(19) United States
(12) Patent Application Publication
(10) Pub. No.: US 2007/0083378 A1
(43) Pub. Date: Apr. 12, 2007

(54) Secure application programming interface

(75) Inventors: Brian J. Guarraci, Redmond, WA (US); Christopher Butler, Redmond, WA (US); Alexandra K. Heron, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/246,476

(22) Filed: Oct. 11, 2005

(51) Int. Cl. G06Q 99/00; G06F 3/00; G06F 17/00; G06F 9/00

(52) U.S. Cl. 705/1; 715/744

(57) ABSTRACT

Secure application programming interfaces are provided to enable communications between one or more services and one or more processes. The secure application programming interfaces expose services to the processes based on the trust level associated with the services and the trust level of the processes. The trust level of the processes are determined by performing a hash on the processes. The services exposed to the processes have a trust level less than or equal to the trust level of the processes. Accordingly, the secure application programming interfaces are generated on the fly based on the needs of the one or more processes.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Currently, processes that require services utilize an application programming interface to access the services. Developers that understand the application programming interfaces may create processes that operate in a computer system that utilizes the application programming interfaces. Unfortunately, malicious developers may use the services provided by the application programming interfaces to perform subversive tasks.

For instance, a developer may create a small process that utilizes services provided by the application programming interfaces to access information that the process may not require. For example, a developer may program an advertisement pop-up window to render on a computing device. The developer may include malicious code in the advertisement pop-up window that attempts to access contact lists provided by a service associated with the application programming interfaces. The malicious code may utilize the application programming interfaces to retrieve the contact lists. This is problematic because the application programming interfaces do not ensure the process is accessing the appropriate information required to perform a legitimate task. Accordingly, a need arises for a method to dynamically limit services accessible by a process.

### SUMMARY

In an embodiment, a secure application programming interface is generated to protect one or more services from malicious processes. An authentication value for a process attempting to access the services is generated. A list of services and the trust levels assigned to the process is provided. A determination is made based on the authentication value and the trust levels to select appropriate services. The secure programming interface implements and exposes the appropriate services.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates a computing architecture utilizing a secure application programming interface, according to embodiments of the invention;

FIG. 2 is a component diagram that illustrates loading components, according to embodiments of the invention;

FIG. 3 is a component diagram that illustrates details of an interface factory, according to embodiments of the invention;

FIG. 4 is a component diagram that illustrates details of a dispatch bridge, according to embodiments of the invention;

FIG. 5 is a component diagram that illustrates details of a relationship between services and a locked dispatch bridge, according to embodiments of the invention; and

FIG. 6 is a flow diagram that illustrates a method to generate the secure application programming interface, according to embodiments of the invention.

### DETAILED DESCRIPTION

Embodiments of the invention provide a secure application programming interface that allows a process to execute one or more services based on a level of trust associated with the processes services. The secure application programming interface is generated at run-time and implements the services that the process requires.

In an embodiment, a developer may generate processes that utilize the secure application programming interfaces to access services that one or more computers may implement. The computers may include script engines that execute scripts associated with the processes. The scripts may utilize a markup language layout and resources to render a display associated with the computer. The resources may include multimedia files that provide content when rendered on a display device. The scripts, markup language layout and resources may be collectively referred to as a widget. The widget is a self-defining object that provides the resources and functionality for one or more processes. Additionally, the widget may be nested, that is, a widget can execute other widgets. The widget is associated with a trust level by generating an authentication value to correspond to a process the script is performing. The computers may include one or more processors, which may include a script processing engine utilized to interpret the scripts associated with the widget. The script engine supports visual basic and java language scripts, or any other suitable script language. In an embodiment of the invention, the script engine may be communicatively connected to the computer through a communication network, and the computer may be a portable device, such as, laptop, personal digital assistant, smart phone, etc.

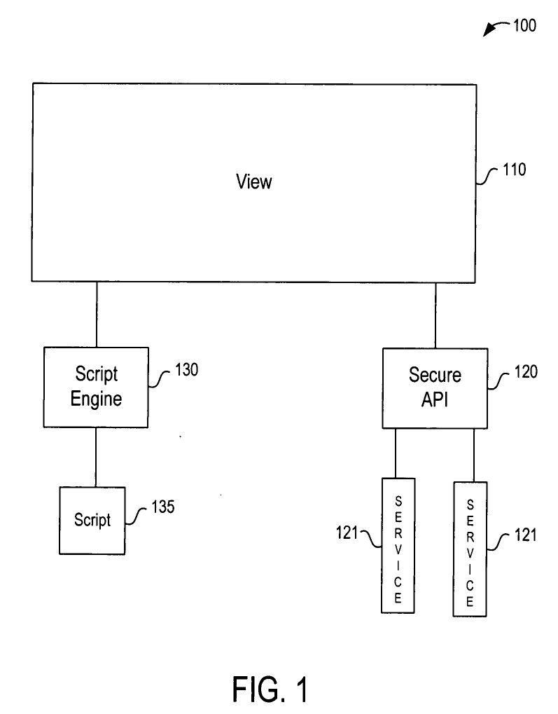

FIG. 1 is a block diagram that illustrates a computing architecture 100 utilizing a secure application programming interface 120, according to embodiments of the invention. The computing architecture 100 includes, among other things, a view 110, the secure application programming interface 120, and a script engine 130.

The view 110 is a run-time representation of output generated by a widget (not shown). The view may provide a display of one or more resources and illustrate the changes that occur to the resources based on the processes executed by the script engine 130. The view is communicatively connected to the script engine 130 and the secure application programming interface 120.

The secure application programming interface 120 is a bridge object that aggregates multiple services 121 and provides access to the services 121 based on a trust level associated with the widget. The script engine 130 requests one or more services 121 from the secure application interface 120. The services 121 returned to the script engine 130 have trust levels that are less than or equal to the trust level associated with the widget. The secure application programming interface 120 is generated for each widget attempting to access one or more services 121. The secure application programming interface 120 is destroyed when the widget is terminated.

The script engine 130 executes the scripts 135 to alter the view 110. The script engine 130 communicates with the secure application programming interface 120 to retrieve services 121 that implement the script 135. The services 121 are provided to the script engine 130, after the services 121 are filtered based on a trust level associated with the widget. When the script 135 requires access to a service 121 that is above the trust level associated with the widget, the script engine 130 is unable to perform the action associated with the service 121. In an embodiment of the invention, the service may include search services, instant messenger services, upload/download services, etc. The computing architecture illustrated in FIG. 1 is exemplary and other configurations are within the scope of the invention.

The secure application programming interface is generated for each widget executing in the computing architecture. The widget is a self-defining collection of items that provide context to enable a script engine to consume the widget. The widget provides the resources, scripts and appropriate markup language information that allows the script engine to properly consume the widget by generating a view or run-time context for the widget. The run-time context includes loading the widget and generating the secure application programming interface to facilitate communication between the services and the script engine. Furthermore, the run-time context renders the appropriate markup language information and resources based on instructions received from the script engine.

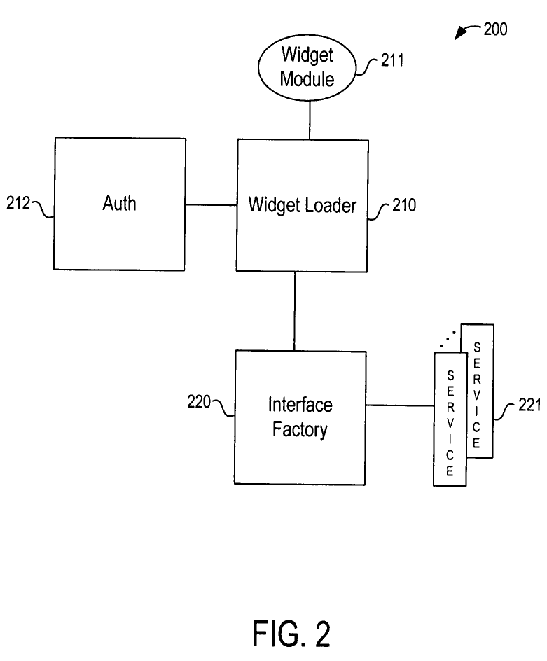

FIG. 2 is a component diagram that illustrates loading components 210 and 220, according to embodiments of the invention. The loading components includes a widget loader 210 and an interface factory 220. The widget loader 210 generates an authentication value for a widget 211 and stores the information in an auth attribute 212. The auth attribute 212 may be used as a widget identifier. The widget loader 210 may calculate the authentication value to associate with the widget by hashing the widget. In an embodiment of the invention, the hash is SHA-1 or MD5. The hash may be generated by hashing the resources, scripts, or markup language layout associated with the widget. Moreover, the hash may be performed on the process generated by the scripts associated with the widget to generate the authentication value by hashing the executable or bytecode associated with the widget. Additionally, the hash may provide a one to one correlation between the widget and the authentication value. If the widget changes a little, the authentication value changes significantly. Secure hash algorithms, such as, SHA-1, SHA-256, or the like may provide the one to one correlation between the authentication value and the widget. Furthermore, a trusted widget is generated by hashing all the contents, including image files, javascript and markup. If the widget is a compressed file, the widget is decompressed and the contents of the compressed file is hashed to generate the authentication value.

The interface factory 220 retrieves the authentication value stored in the auth attribute 212 and generates a secure application programming interface based on the authentication value of the widget. The interface factory 220 has access to a collection of services 221 having varying trust levels. The secure application programming interface implements a subset of the services 221 based on a relationship between the authentication value of the widget and trust level of the services 221. In an embodiment of the invention, the collection of services 221 and corresponding trust levels may be generated by a trusted authority. Furthermore, the collection of services 221 and trust levels may be pre-defined by a computer storing the widget.

The interface factory 220 generates the secure application interface to provide the script engine with the appropriate services 221. The interface factory 220 retrieves the collection of services 221. The interface factory creates a bridge object to store a subset of the collection of services 221, after the collection of services 221 are filtered based on an authentication level. The services 221 with trust levels higher than the authentication level are removed. The bridge object exposes the stored services 221 to the script engine to allow access to the services 221.

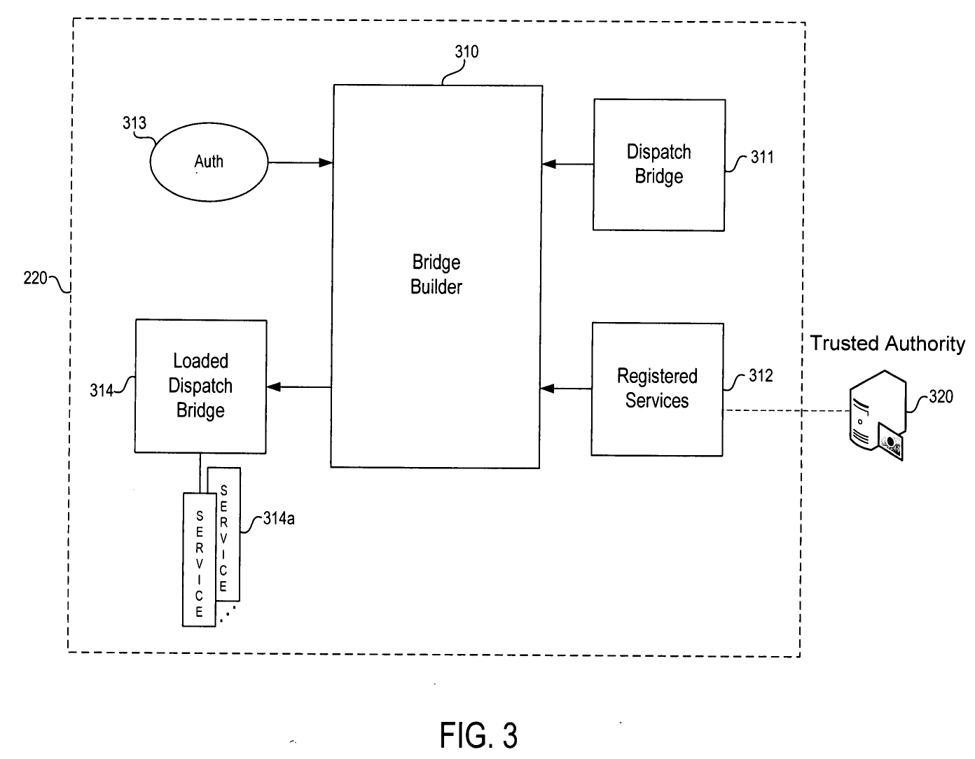

FIG. 3 is a component diagram that illustrates details of the interface factory 220, according to embodiments of the invention. The interface factory 220 includes a bridge builder 310 that receives registered services 312, dispatch bridge 311 and auth attribute 313, and outputs a loaded dispatch bride 314. The auth attribute 313 stores the authentication value of the widget. The bridge builder 310 utilizes the authentication value stored in auth attribute 313 to generate the loaded dispatch bridge 314 having one or more services 314a. The bridge builder 310 retrieves a collection of registered services 312 associated with a host of the widget. The registered services 312 may include restricted services 312 that the widget should not access because of the authentication value of the widget. The bridge builder 310 creates the dispatch bridge 311 to implement a subset of the registered services based on the authentication value of the widget. The dispatch bridge 311 is populated with the registered services 312, where the trust levels of the registered services 312 are less than or equal to the authentication value of the widget. The bridge builder 310 outputs the loaded dispatch bridge 314 with the services 314a representing a subset of the registered services 312 having the appropriate level of trust. In an embodiment of the invention, the registered services 312 include a time limit that specifies how long a registered service 312 is available to the widget. The registered services 312 provided to the bridge builder 310 may be contingent on a contract specifying a payment amount for the registered service 312 and a duration of time, defining the validity of a widget's right to access the registered service 312. When the contract expires, the registered services 312 are altered to reflect the expiration of one or more rights to access a collection of services.

Optionally, the bridge builder 310 may communicate with an external trusted authority (TA) 320 to generate the subset of services based on the authentication value. After the authentication value is computed, the bridge builder 310 communicates the authentication value to the TA 320. In an embodiment, the TA 320 performs a table look-up to determine the services associated with the specified authentication value. The TA 320 returns a trust level that represents a class or collection of services. The bridge builder 310 filters the registered services 312 to remove the services that are not in the class or adds services that are in the class. The bridge builder 310 may have a predetermined service map that translates the authentication value to the appropriate service, and the bridge builder 310 may communicate with the TA 320 to receive updates to the service map. Accordingly, the bridge builder 310 is flexible and scalable based on the class of services returned by the TA 320.

In an embodiment of the invention, the widget may be a web page having an associated level of trust. The level of trust may be generated by performing a hash on the contents of the web page. A secure application programming interface stores information on services that each web page should have access to based on a contract specifying whether a webpage is a business partner, and the types of service provided based on the payments received from the owner of the web page. The secure application programming interface associated with the web page is dynamically generated based on the level of trust associated with web page. The secure application programming interface exposes services to the web page depending on the levels of trust of the web page and the services. When the level of trust of the service is higher than the level of trust associated with the web page, the service is not exposed to the web page. The web page may be provided with a base line set of services, when the level of trust for the web page is below a specified threshold value.

In an embodiment of the invention, the secure application programming interface may be generated by a dispatch bridge. The dispatch bridge may utilize two components to generate the secure application programming interface. The two components are a dynamic bridge and a locked bridge. The locked and dynamic bridges have a closed and protected relationship, such as, a C++ friend relationship. The friend relationship allows the dynamic bridge to access the locked bridge to update services implemented by the locked bridge. After the locked bridge is populated with appropriate services the dynamic bridge is destroyed. The locked bridge may not be modified after the dynamic bridge is destroyed. The locked bridge is returned as the secure programming application interface.

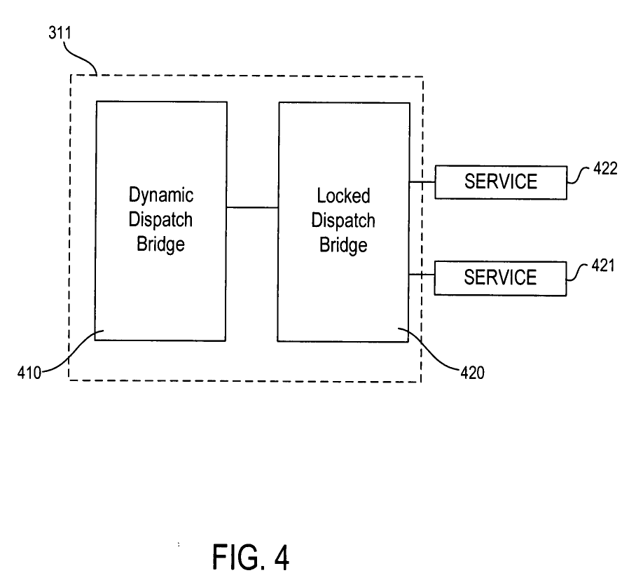

FIG. 4 is a component diagram that illustrates details of the dispatch bridge 311, according to embodiments of the invention.

The dispatch bridge 311 includes a dynamic dispatch bridge 410 and a locked dispatch bridge 420. The dynamic dispatch bridge 410 has a friend relationship with the locked dispatch bridge 420. The locked dispatch bridge 420 includes a collection of services 422 and 421. The collection of services 420 and 421 are added to the locked dispatch bridge 420 by the dynamic dispatch bridge 410. The dynamic dispatch bridge 410 adds the services 420 and 421 to the locked dispatch bridge 420, after the bridge builder determines which of the registered services have the appropriate trust level based on the authentication value of the widget. The dynamic dispatch bridge 410 utilizes private member functions of the locked dispatch bridge 420 to register services with the locked dispatch bridge 420. After the locked dispatch bridge 420 is populated with the appropriate services 421 and 422, the dynamic dispatch bridge 410 is destroyed and the locked dispatch bridge 410 is passed to the script engine to facilitate communication with the services 422 and 421.

In an embodiment of the invention, the widget, secure application programming interface, and services may be component object model (COM) objects that adhere to the implementation rules for COM objects. Here, the locked dispatch bridge would implement IUnknown and IDispatch to allow the other COM objects to communicate with the locked bridge. When the locked dispatch bridge implements IDispatch, the other COM objects may query the locked bridge to determine the services provided based on the trust level of the widget. Also, the locked dispatch bridge implements IUnknown to allow other COM objects to reference the locked dispatch bridge. Accordingly, the locked bridge may communicate with the other COM objects to allow information exchange.

After the secure application programming interface is exposed to the script engine, a communication protocol is utilized to allow the secure application programming interface to handle events generated by the services and method calls created by the script. The communication protocol is transparent to the services, the script, and the script engine. The secure application programming interface utilizes the relationship between the service and secure application programming interface to allow communication. Accordingly, the secure application programming interface seamlessly routes the events and method calls between the services and the script engine.

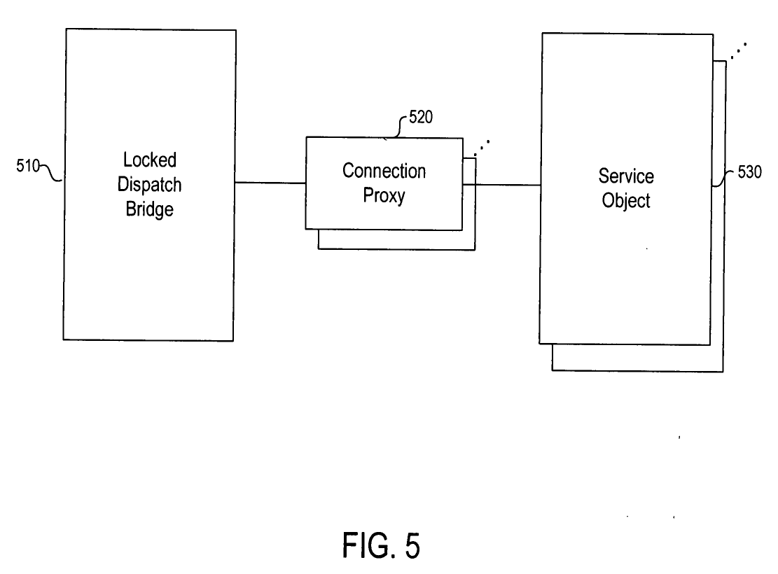

FIG. 5 is a component diagram that illustrates details of the relationship between service objects 530 and the locked dispatch bridge 510, according to embodiments of the invention. A connection proxy 520 provides the relationship between the service object 530 and the locked dispatch bridge 510. The connection proxy 520 routes event generated by a service object 530 to the locked dispatch bridge 510 and maps the appropriate namespace to the event. For instance, if an event is generated by the service object 530, which may be a messenger object, the connection proxy 520 maps the event to the messenger namespace by concatenating the name of the event with the name provided by the connection proxy 520 to generate an appropriate message and route the appropriate message, such as, “Messenger_Event” to the script engine. The script engine receives the appropriate message and processes the appropriate message. After the appropriate message is propagated to the script engine, an action is generated. When the script engine generates a method call, the method call is mapped to the locked dispatch bridge 510 by concatenating a name associated with the locked dispatch bridge 510 with the method call. For instance, locked dispatch bridge 510 may be named secure and a method call to the messenger service would generate “Secure.messenger.” The message would be routed to the locked dispatch bridge 510, and the locked dispatch bridge 510 would pass the message to the appropriate service object 530. If the locked dispatch bridge 510 does not implement the service object specified in the message, the script engine may not perform the task associated with the method call. Accordingly, the secure application programming interface ensures that the process associated with the script accesses the appropriate services when executing the process. The process will be allowed access only to the specified services included in the secure application programming interface.

A locked dispatch bridge provides the security that enables the secure application programming interface. Creating the secure application programming interface allows the widget to access services based on trust levels required to access the service. After populating the secure application programming interface with the appropriate services the secure application programming interface is exposed to the script engine.

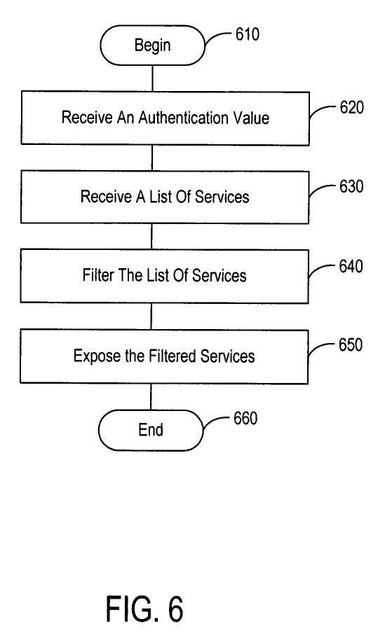

FIG. 6 is a flow diagram that illustrates a method to generate the secure application programming interface, according to embodiments of the invention.

The method begins when a widget is loaded, in step 610. An authentication value associated with the widget is received, in step 620. A listing of registered services and trust levels associated with the services are received, in step 630. The listing of registered services is filtered based on the authentication value, in step 640. The registered services that have a trust level above the authentication value are removed from the listing of registered services. The remaining registered service are added to the secure application programming interface and exposed, in step 650. The process ends in step 660.

In sum, a widget utilizes the secure application interface to access services based on the authentication level associated with the widget. A separate secure application interface is generated at run time for each widget executing on the computer. The secure application interface provides communication security to allow only authorized widgets to receive the events and method calls associated with the service.

In an alternative embodiment, a method to pass events between the services and the secure application programming interface is provided. Events are generated by service objects and are routed through a connection proxy to the secure application programming interface. The secure application programming interface maps the events from the service object to the script engine and generates event messages having the proper namespace to allow the script engine to perform an action based on the generated event. The connection proxy provides the context information that enables the secure application processing interface to map the event to the service.

The foregoing descriptions of the invention are illustrative, and modifications in configuration and implementation will occur to persons skilled in the art. For instance, while the present invention has generally been described with relation to FIGS. 1-6, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

We claim:

1. One or more computer readable media storing instructions to consume a widget, the instructions perform a method comprising:
receiving a widget identifier;
receiving a list of services and corresponding trust levels assigned to the services;
selecting a subset services based on the widget identifier; and
and exposing the subset of the services to the widget.

2. The computer readable media according to claim 1, wherein the subset of the services include services having a trust level less than or equal to the widget identifier.

3. The computer readable media according to claim 1, further comprising: executing the widget by utilizing the subset of services.

4. The computer readable media according to claim 1, wherein the widget identifier is a hash of the widget.

5. The computer readable media according to claim 1, wherein the widget is a process.

6. The computer readable media according to claim 1, wherein the widget is a collection of resources and scripts.

7. The computer readable media according to claim 1, wherein the widget is web page.

8. One or more computer readable media storing instructions to generate a secure application programming interface, the instructions perform a method comprising:
receiving an authentication value associated with a process;
receiving a package having a plurality of services and trust levels associated with the plurality of services;
filtering the package to remove services having a trust level greater than the authentication value; and
populating the secure application programming interface with the services in the filtered package.

9. The computer readable media according to claim 8, further comprising: locking the secure application programming interface.

10. The computer readable media according to claim 8, further comprising: exposing the secure application programming interface.

11. The computer readable media according to claim 8, further comprising: attaching the secure application programming interface to a script engine.

12. The computer readable media according to claim 8, wherein the authentication value is a hash of the process.

13. The computer readable media according to claim 12, wherein the hash is SHA-1.

14. A computer-implemented method to generate a locked dispatch bridge, the method comprising:
instantiating a dispatch bridge having a dynamic bridge and a locked bridge;
receiving an authentication value;
receiving a list of services and trust levels assigned to the services; and
utilizing the dynamic bridge to populate the locked bridge with a subset of the services.

15. The computer-implemented method according to claim 14, wherein the dynamic bridge and locked bridge have a friend relationship.

16. The computer-implemented method according to claim 14, further comprising: destroying the dynamic bridge.

17. The computer-implemented method according to claim 14, further comprising: exposing the locked bridge.

18. The computer-implemented method according to claim 14, wherein the subset of services include services having a trust level less than or equal to the authentication value.

19. The computer-implemented method according to claim 18, wherein the authentication value is a hash of a process that requires one or more services.

20. A computer system having a memory and processor to execute the computer-implemented method as recited claim 14.
